(19) United States
(12) Patent Application Publication
(10) Pub. No.: US 2020/0309253 A1
(43) Pub. Date: Oct. 1, 2020

(54) TOUCHSHIFTER

(71) Applicant: ZF Friedrichshafen AG, Friedrichshafen (DE)

(72) Inventors: Vitali Fribus, Quakenbrück (DE); Ludger Rake, Steinfeld (DE); Karsten Strassburg, Hannover (DE); Lenard Petrzik, Osnabrück (DE)

(73) Assignee: ZF Friedrichshafen AG, Friedrichshafen (DE)

(21) Appl. No.: 16/068,065

(22) PCT Filed: Dec. 8, 2016
(86) PCT No.: PCT/EP2016/080194

§ 371 Date: Jul. 3, 2018

(30) Foreign Application Priority Data
Jan. 5, 2016 (DE) DE102016200020.9

(51) Int. Cl. F16H 59/08; F16H 63/42; F16H 61/02; F16H 61/21; F16H 61/24; G06F 3/0488; G06F 3/0486

(52) U.S. Cl. CPC F16H 59/08; F16H 63/42; F16H 61/0204; F16H 61/21; G06F 2203/014; G06F 3/0488; G06F 3/0486; F16H 2063/423; G06F 2203/04809; F16H 61/24

(57) ABSTRACT

An operating device for a shift by wire assembly in an automobile may include a touch sensitive display for selecting an operation mode of a transmission of the automobile and a haptic guide element configured to guide a touch gesture of an operator corresponding to the selection of the operation mode. The touch sensitive display may be configured to display an image, the image being a graphical, interactive user-interface object that can be moved with the touch gesture of the operator into a predetermined area of the touch sensitive display for selecting the operation mode. The haptic guide element may include at least one selection path along which the image can be moved.

The present disclosure relates to an operating device for a shift by wire assembly in an automobile comprising a touch sensitive display for selecting an operation mode of an automatic and/or automatized transmission of the automobile, further comprising a haptic guide element that serves to guide a touch gesture of an operator corresponding to the selection of the operation mode.

Such operating devices generally comprise a communication interface, one or more processors, memory and one or more programs, wherein the one or more programs are stored in the memory and configured to be executed by the one or more processors, said programs including instructions for detecting contact with the touch sensitive display, in particular touch gestures of an operator of the automobile, and outputting an operation mode selection signal via the communication interface when said contact corresponds to a predefined touch gesture for selecting one of the said operation modes.

An operating device of this sort is disclosed in the US Patent Application Publication US2012/0041655A1, wherein it is disclosed that a vector defined by two coordinates resulting from a digital pressure applied by an operator of an automobile is compared to predetermined requirements on the length and orientation of the vector for validating a desired command. It is further disclosed that an element for protecting the touchscreen can be placed over the screen, and that said element has a cutout for permitting digital access to the touchscreen, such that a finger of the operator can exert pressure and move corresponding to the activation of a desired command.

In this context, the object of the present embodiments is to suggest an operating device for changing transmission modes in an automobile that enables simple and error free operation.

The object of the present embodiments is achieved with the subject matter of independent claims. The dependent claims describe preferred embodiments of the disclosure.

The object of the present embodiments, then, is achieved with an operating device for a shift by wire assembly in an automobile comprising a touch sensitive display for selecting an operation mode of an automatic and/or automatized transmission of the automobile, further comprising a haptic guide element that serves to guide a touch gesture of an operator corresponding to the selection of the operation mode, wherein the touch sensitive display is configured to display an image, said image being a graphical, interactive user-interface object, which can be moved with the touch gesture of the operator into a predetermined area of the touch sensitive display for selecting a certain operation mode, and wherein the haptic guide element provides at least one selection path along which the image can be moved. The operator, or user, therefore drags, i.e. moves, the image into an area of the touch sensitive display thereby triggering a signal to a transmission controller element, requesting and/or prompting the selection of said operation mode.

An operating device of this sort permits a certain amount of flexibility in setting the requirements for triggering the operation mode selection signal. The probability that an inadvertent operation mode selection will be made can be decreased by setting requirements such as, for example, that the image remain in the predetermined area for a certain minimum period of time, for example 1 second, before the operation mode of the transmission is selected. This serves to prevent an inadvertent transmission mode selection through accidental contact with the touch sensitive display for example. Preferably, the operation mode selection signal is triggered by a touch gesture that comprises moving the image into the predetermined area and releasing the image, i.e. removing pressure from the touch sensitive display, when the image is within the predetermined area.

A successful selection of an operation mode can be displayed visually by the touch sensitive display. Furthermore, a haptic and/or auditory feedback can be output to the operator in order to signal a successful or unsuccessful operation mode selection. For example, a hand rest can be provided for the touch sensitive display for supporting the hand of the operator, said hand rest serving to give haptic feedback to the operator. For example, the hand rest can comprise a vibration generator and/or heater or other means in order to give a tactile feedback signal to the operator indicating a successful and/or incomplete and/or unsuccessful operation mode selection. The hand rest could be embodied to take on a certain form, texture or level of hardness or pliability or any other tactile response in order to signal the operator. An auditory feedback signal indicating a successful and/or incomplete and/or unsuccessful operation mode selection can be output to the operator over a speaker of the automobile. In order to achieve this, the communication interface of the operating device can be used to transmit a signal to a processor and/or controller for controlling the speaker.

A tactile and/or haptic feedback signal can also be output by piezo actuators, for example, or even by the surface to the touch sensitive display itself. In order to realize a haptic feedback from the surface the touch sensitive display, technologies such as those being developed by companies specializing in haptic feedback technologies, such as the company Senseg, Fujitsu, or Immersion in the year 2015, for example, can be incorporated into the touch sensitive display. These technologies can be based, for example, on the manipulation of electrostatic forces between the surface of the touch sensitive display and an operator's finger by employing an electrostatic layer. Alternatively such technologies can involve the manipulation of ultrasonic vibrations on the surface of the screen, for example, in order to generate the haptic feedback.

The touch sensitive display could, for example, be an organic light emitting diode display with an integrated touch sensor system, molded together through a process involving film-insert-molded electronics for example. Alternatively, the touch sensitive display can comprise a rear projection polycarbonate film with an integrated and/or attached touch sensor system. The haptic guide element can, for example, be molded together with the display surface, or even be comprised by the display surface itself.

In an embodiment of the operating device the at least one selection path comprises a first segment and a second segment, wherein the first segment is oriented such that the image can be moved along a first direction and the second segment is oriented such that the image can be moved along a second direction, the second direction being different from the first direction and not the opposite of the first direction. The first and second segments are therefore not parallel to each other, and the selection of an operation mode of the transmission requires the operator to perform a touch gesture that moves the image along the first segment in a predefined direction and subsequently, to move the image along the second segment, also in a predefined direction. The first and second segments can be directly linked to each other, for example, being connected to each other at a node and/or by sharing an area of the touch sensitive display as a transitional zone. Since the selection path is segmented in this way, it is only possible to select an operation mode of the transmission by moving the image in a first direction and then in a second direction, reducing the chances that a transmission mode selection can be made inadvertently.

When more than one selection path is provided such that more than one operation mode of the transmission can be selected, then all or some of the selection paths can share a first segment.

In an embodiment of the operating device the touch sensitive display is configured to display the image at a start position and/or move the image to the start position in a passive operating state, and is configured to display the image according to the touch gesture of the operator in an active operating state, wherein the touch sensitive display transitions to the passive operating state after the operation mode of the transmission has been selected. The passive operating state can be also be transitioned to whenever the operator withdraws from contact with the touch sensitive display, so that the operating device is essentially a monostabile operating device. That is, when the operator performs a touch gesture, the touch sensitive display transitions to the active operating state, thereby displaying the image in accordance with the operator's gesture. When the touch gesture is interrupted or completed and the operator stops contacting the touch sensitive display, the image will be displayed moving back to the start position or at the start position, in accordance with the passive operating state. The operating device can therefore imitate traditional monostabile gear shift levers, while greatly reducing the mechanical complexity required.

In an embodiment of the operating device the selection path comprises a transition area between the first segment and the second segment, and that when the operator's touch gesture moves the image into said transitional area, an operation mode of the transmission is selected in which an interruption in torque transmission occurs. Since the operation modes of the transmission are selected via this transition area for the interruption of the torque transmission, i.e. via neutral, the risk of damage to the gear change mechanism due to an operator error in operating the operation device is reduced regardless of an electronic safety circuit that may be additionally present.

In an embodiment of the operating device the haptic guide element provides more than one selection path, and each selection path is geometrically unique from all other selection paths provided by the haptic guide element. A selection path can be considered to be geometrically unique in connection with the present embodiments, if the path has a unique form and/or has a unique spatial orientation. An operator can thereby determine, when making contact with the operation device, which selection path is being contacted through touch, i.e. tactile feedback, alone. The collection of selection paths can be considered to be a shift pattern. Based on physically feeling the geometrical form of a single selection path provided by the haptic guide element, the operator can determine where in the shift pattern contact is being made, and further can determined where the start position is for performing a touch gesture for selecting an operating mode of the transmission. The start position can additionally be uniquely indicated by the haptic guide element. For example, the location of the start position on the touch sensitive display can be indicated by a depression in the haptic guide element. The depression can have a unique form, such as a circular or rectangular form, for example.

In an embodiment of the operating device the predetermined area for selecting the operation mode of the transmission is displayed on the touch sensitive display. Further, the touch sensitive display can be configured to display the currently selected operation mode of the transmission, in particular by displaying it at the location of the predetermined area designated for selecting the currently selected operation mode.

In an embodiment of the operating device a braking selection path is provided to increase the engine braking and/or electric motor braking of the automobile wherein the engine braking and/or electric motor braking can be incrementally increased in accordance with the distance the image is moved by the touch gesture of the operator. In some automobiles, in particular electrically powered hybrid automobiles, it is possible to select a brake recuperation operation mode, which can increase the amount of braking accomplished by the engine and/or an electric motor, since traditional transmission boxes may not be available to increase stopping power with low gears when traveling down long hills, example. This helps to increase the operational lifetime of normal hydraulic brakes. When kinetic energy of the automobile is transferred to an electric motor of the vehicle, the motor can serve as a generator for an energy storage unit, in particular a battery, in the vehicle. The operating device with a selection path for selecting such a braking recuperation operation mode thereby permits the operator to select such an operating mode in a simple way. By enabling an operator to control the amount of engine braking and/or electric motor braking of the automobile in an incremental way, the operating device permits the operator to adjust the braking to the specific driving situation, thereby increasing the flexibility and control of the braking recuperation operation mode that has not been traditionally possible.

In an advantageous embodiment of the operating device the haptic guide element is a molded plastic element wherein the selection path is formed by an elevated and/or depressed contour of the molded plastic element. The touch sensitive display can be, for example, a liquid crystal display or thin film transistor display having integrated touch sensors. In this case, the haptic guide element can, for example, comprise a molded plastic attachment for covering the touch sensitive display, for example. The thickness of the plastic element in that case, should be small enough so as to not interfere with the precision of the surface of the display.

In an advantageous embodiment of the operating device a surface of the haptic guide element comprises at least two surface textures, the textures being comprised by the surface of the touch sensitive display and/or a molded plastic attachment of the touch sensitive display. The textures can be used to indicate the selection paths and/or start position. For example, a first texture could be the flat surface of a traditional touch sensitive display, and a second texture for increasing a coefficient of friction during a touch gesture, for example, could be provided to indicate the location of a selection path. The second texture could, for example, be retrospectively machined or etched into the surface of the touch sensitive display or molded plastic attachment. Alternatively, the touch sensitive display could be manufactured or formed, from a polycarbonate film for example, to comprise differing textures. Additionally, locations on the touch sensitive display, such as the location of the start position for example, can be particularly designated with a unique texture.

In an advantageous embodiment of the operating device that haptic guide element comprises an electrostatic layer for inducing tactile response on the surface of the touch sensitive display. Electrostatic layer of this sort have been developed by companies, such as the company Senseg for example, for giving haptic feedback to touchscreen users. A haptic guide element comprising a layer of this sort could be used to provide the touch sensitive display with texture variations to delineate a selection path and/or a start position. For example, a coefficient of friction between an operator's finger and the touch sensitive display can be increased or decreased, or even varied according to a particular predetermined pattern as the finger moves across the surface of the touch sensitive display, by such an electrostatic layer.

Certain embodiments will next be explained in detail with reference to the following figures. They show:

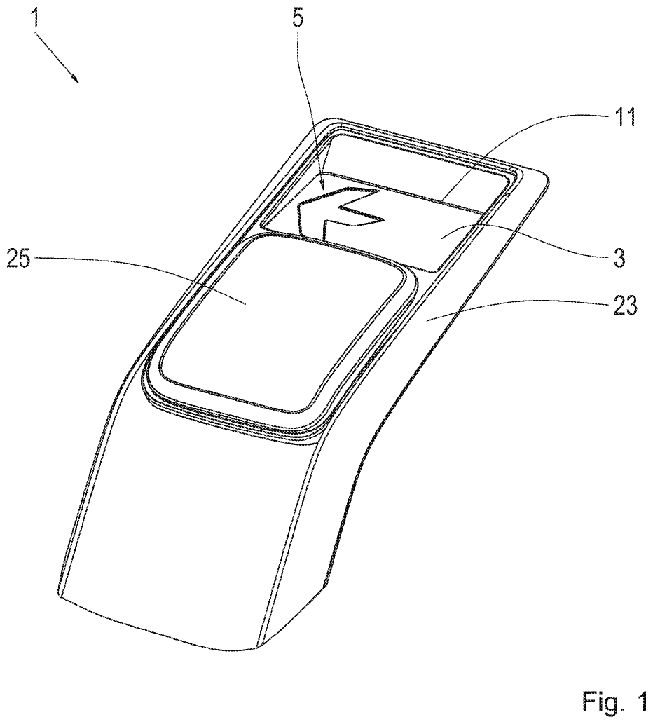

FIG. 1: a perspective view of an embodiment of the present disclosure;

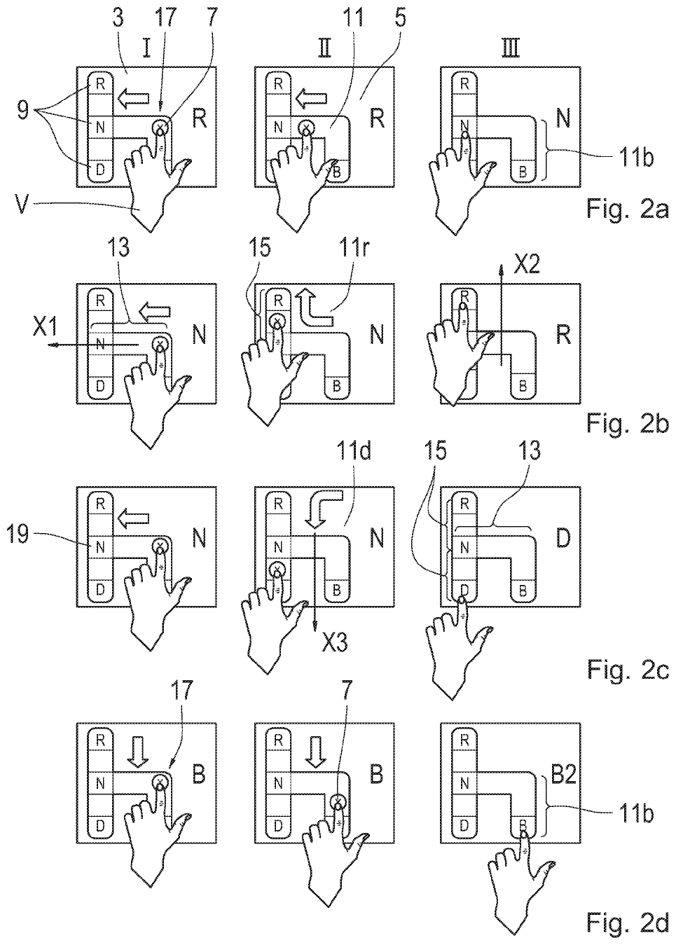

FIG. 2ad: a schematic representation of various operation mode selection gestures according to an embodiment of the present disclosure;

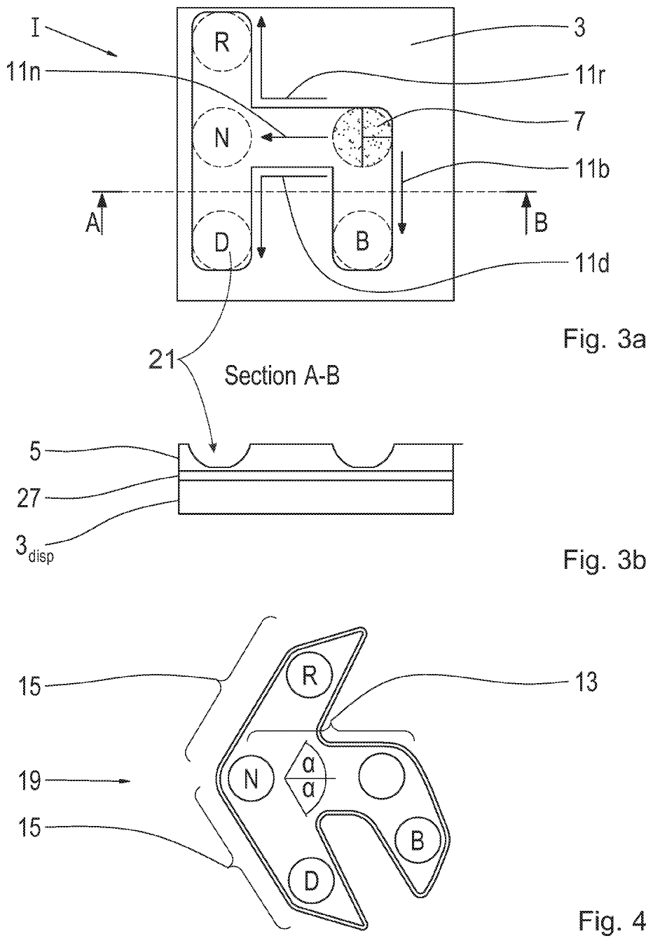

FIG. 3a, b: a sectional top view and a sectional side view of an embodiment of the present disclosure; and

FIG. 4: a schematic representation of an embodiment of the present disclosure.

FIG. 1 shows a perspective view of an embodiment of the present disclosure, which can be installed, for example, in the center console of an automobile. The embodiment comprises a structural element 23, a hand rest 25, and a touch sensitive display 3. The structural element 23 serves to support the hand rest 25 and touch sensitive display 3, and further serves as a housing for the hand rest 25 and the touch sensitive display 3.

The hand rest 25 serves to support the hand and/or arm of an operator V of the automobile and is further embodied to produce haptic feedback for signaling the operator V according to touch gestures performed by the operator V and/or the success of an operation mode R, N, D, B selection.

The touch sensitive display 3 is partially enclosed by the structural element 23 on three sides, which decreases the likelihood that contact with the touch sensitive display 3 will inadvertently be made by the operator V of the automobile or another occupant of the automobile. The touch sensitive display 3 is also partially covered with a haptic guide element 5, which is a molded plastic element. The molded plastic element comprises a depressed portion 21, i.e. contour 21, which permits access to the surface of the touch sensitive display 3 and serves to guide a finger of the operator V along selection paths 11 displayed on the display 3 for selecting operation modes R, N, D, B of the transmission.

FIG. 2a shows a schematic representation of a touch gesture for selecting an operation mode N in which the torque transmission is interrupted, also known as neutral N, according to an embodiment of the present disclosure. In particular, the neutral operation mode N is selected by the depicted touch gesture when, initially, a reverse operation mode R is engaged. The operation mode R, N, D, B that is initially, i.e. currently, engaged is displayed by the touch sensitive display 3. At the beginning of the touch gesture, the operator V places a finger at the start position 17, designated by the haptic guide element 5, and thereby selects the image 7, i.e. the interactive user-interface object, displayed on the display 3. This is depicted in the first frame I of FIG. 2a. The contact between the finger and the surface of the touch sensitive display 3 is detected by sensors. When the contact is detected, a program stored in the memory of the device 1 can issue instructions to change the appearance of the image 7. The second frame II of FIG. 2a shows the operator V moving the image along the selection path 11 in a first direction, towards an area 9 of the touch sensitive display 3 designated for selecting the operation mode N in which the torque transmission is interrupted. When the touch gesture of the operator V causes the image to reach the area 9 of the touch sensitive display 3 designated for selecting neutral N, the operator can release, i.e. “drop”, the image 7 by relinquishing contact with the display 3. When the sensors stop detecting the contact with the touch sensitive display 3 a program run by a processor of the device 1 issues instructions to prompt the selection of an operation mode N in the transmission, for example by sending instructions via a communication interface of the device 1 over a data connection to a controller for the transmission. A program run by the processor is at the same time configured to issue instructions to the display 3 to change the appearance of the image 7 and/or the area 9 of the touch sensitive display 3 designated for selecting the neutral operation mode N. Furthermore, if the selection of the operation mode N is successfully carried out by the transmission controller, then instructions are issued to the display 3 to display the newly selected operation mode N. This is displayed in the third frame III of FIG. 2a. Haptic and/or acoustic feedback can also be output to the operator V with the hand rest as displayed in FIG. 1, for example, or the speakers of the automobile, respectively.

In FIG. 2b a schematic representation of a touch gesture for selecting a reverse operation mode R of the transmission is shown according to an embodiment of the invention, wherein the neutral operation mode N is initially engaged. In the first frame I, the operator V selects the image 7 at the start position 17. In the embodiment of the present disclosure shown here, the image 7 reverts back to the start position 17 whenever the operator V relinquishes contact with the touch sensitive display 3.

In the second frame II of FIG. 2b the operator V moves the image 7 along a selection path 11r for the reverse operation mode R, as indicated by the directional arrow. The selection path 11r for the reverse operation mode R comprises two segments 13, 15. The first segment 13 essentially comprises the selection path 11n for the neutral, i.e. no gear, operation mode N. The second segment 15 of the selection path 11r for selecting the reverse operation mode R is arranged such that the movement of the image 7 in the second segment 15 is in a second direction X2, in particular essentially perpendicular, to the direction of the movement of the image 7 in the first segment 13. The second direction X2 is also not the opposite of the first direction X1. The transitional area 19 between the two segments 13, 15 essentially corresponds to the area 9 of the touch sensitive display 3 that is designated for selecting the neutral operation mode N.

In the third frame III of FIG. 2b the selection of the reverse operation mode R is displayed, wherein the operator V drops the image 7 in an area designated 9 and displayed on the touch sensitive display 3 for selecting the reverse operation mode R. That is, the operator V lifts his or her finger from the touch sensitive display 3 when the image 7 is positioned in this area 9 of the display 3.

FIG. 2c shows a schematic representation of a touch gesture for selecting a drive operation mode D of the transmission is shown according to an embodiment of the present disclosure, wherein the neutral operation mode N is initially engaged. The three frames I, II, III shown in FIG. 2c correspond to the three frames as described in connection with FIG. 2b. The selection path 11d for selecting the drive operation mode D shares a common first segment 13 with the selection path for selecting the reverse operation mode R and the neutral operation mode N. In contrast to the touch gesture for selecting the reverse operation mode R, the second segment 15 of the selection path 11d for selecting the drive operation mode D is oriented so as to provide a third direction X3 in which an operator V can move the image 7. The third direction X3 differs from the first direction provided by the first segment 13 of the selection path 11n, 11r, 11d, and not opposite to the first direction X1. The third direction X3 is furthermore different from the second direction X2 provided by the second segment 15 of the selection path 11r for selecting the reverse operation mode R.

FIG. 2d shows a schematic representation of a touch gesture for selecting an operation mode B of the transmission for increasing the braking capacity of the engine and/or electric motor of the automobile, according to an embodiment of the invention. In a first frame I of FIG. 2d, the operator V has contacted the touch sensitive display 3 at the start position 17 and slightly moved the image 7 along the selection path 11b for selecting the braking operation mode B. The touch sensitive display 3 senses the touch gesture of the operator V and immediately a program in the memory of the device 1 issues instructions to increase the engine braking and/or electric motor braking. Instructions are furthermore issued to the display 3 so that the selection of the braking operation mode B is visually displayed.

In the second frame II of FIG. 2d, the operator V has moved the image 7 further along the selection path 11b in the direction indicated by the directional arrow. The movement of the image 7 and relatedly the point of contact of the operator V on the touch sensitive display 3 is monitored by sensors of the device 1 and serves as basis for issuing instructions to increase the braking function of the engine and/or electric motor incrementally in accordance with the distance along the selection path 11b the image 7 has been moved. The third frame of the FIG. 2d shows the end of the touch gesture, wherein the operator V has moved the image 7 to the end of the selection path 11b and relinquished contact with the surface of the display 3 so that the braking operation mode B is selected. The final selection of the braking operation mode B can be displayed by the display 3 in a unique way B2 so that the operator V of the automobile can visually verify that the braking operation mode B has been visually selected.

FIG. 3a shows a sectional top view of an embodiment of the present disclosure, wherein selection paths 11 are displayed for selecting various operation modes R, N, D, B. The selection paths 11r, n, d, b are arranged to be unique in that each selection path 11r, n, d, b has either a unique form and/or a unique spatial orientation, with respect to the other selection paths 11r, n, d, b shown. An operator 11r, n, d, b of the automobile can therefore distinguish by touch alone, where within the shift pattern comprising the selection paths 11r, n, d, b contact is being made.

FIG. 3b shows a sectional side view of the construction of a touch sensitive display 3 having a haptic guide element 5 according to an embodiment of the present disclosure. The sectional view displays three layers. The first layer corresponds to the haptic guide element 5, which is shown comprising recessed areas 21. These recesses 21 serve as contours 21 that define the selection paths 11r, n, d, b. A second layer shown in FIG. 3b comprises a touch sensitive layer 27 for monitoring pressure applied to the surface of the touch sensitive display 3. Pressure can be applied by an operator's V finger, for example, via the haptic guide element 5, when the finger is passed along a contour 21 defining a selection path 11r, n, d, b. A third layer displayed corresponds to a display 3disp for displaying the image 7 as well as the areas 9 designated for selecting the various operation modes R, N, D, B. The image 7 can be displayed by the display 3disp such that the when contact with the surface of the touch sensitive display 3 is withdrawn, the image 7 is displayed by the display 3disp moving back to the start position 17.

FIG. 4 shows a schematic representation of an embodiment of the present disclosure wherein the segments 13, 15 of the selection paths 11r, n, d, b are no longer arranged essentially perpendicular to each other. Instead, the selection paths 11r, 11 d for selecting the reverse and drive operation modes R, D are arranged such that they share a first segment 13, but the second segments 15 of the respective selection paths 11r, 11 d are angled backwards with respect to the first direction X1 provided by the first segment 13, respectively forming acute angles α with the first segment 13 originating at the transitional area 19. This orientation of the respective second segments 15 of the selection pathways 11r, 11 d fulfills the requirements that the second direction X2 provided by the second segment 15 be a direction different from the first direction X1, while not being opposite to the first direction X1, and furthermore, each selection pathway 11r, n, d, b has a unique form and/or spatial orientation. The arrangement of the selection pathways 11r, n, d, b displayed in FIG. 4 provides for a more intuitive and comfortable operation of the operating device 1, in particular for operators V using a right hand to perform touch gestures. For operators V of the automobile who use a left hand to perform touch gestures, the shift pattern formed by the selection paths 11r, n, d, b could of course be inverted, i.e. reflected, or arranged in another way.

### REFERENCE CHARACTERS

1 operating device
3 touch sensitive display
5 haptic guide element
7 image
9 selection area
11r,n,d,b selection path for reverse, neutral, drive, braking
13 first segment of selection path
15 second segment of selection path
17 start position
19 transitional area
21 contour
23 structural element
25 hand rest
27 touch sensitive layer
R, N, D, B operation modes reverse, neutral, drive, braking
V operator
X1, X2, X3 first, second, third direction

1. An operating device for a shift by wire assembly in an automobile, the operating device comprising:
a touch sensitive display for selecting an operation mode of a transmission of the automobile; and
a haptic guide element configured to guide a touch gesture of an operator corresponding to the selection of the operation mode,
wherein the touch sensitive display is configured to display an image, the image being a graphical, interactive user-interface object that can be moved with the touch gesture of the operator into a predetermined area of the touch sensitive display for selecting the operation mode, and
wherein the haptic guide element provides includes at least one selection path along which the image can be moved.

2. The operating device according to claim 1, wherein the at least one selection path includes a first segment and a second segment, wherein the first segment is oriented such that the image can be moved along a first direction and the second segment is oriented such that the image can be moved along a second direction, the second direction being different from the first direction and not the opposite of the first direction.

3. The operating device according to claim 1, wherein the touch sensitive display is configured to display the image at a start position and/or move the image to the start position in a passive operating state, and wherein the touch sensitive display is configured to display the image based on the touch gesture of the operator in an active operating state, and wherein the touch sensitive display transitions to the passive operating state after the operation mode of the transmission has been selected.

4. The operating device according to claim 1, characterized in that wherein the selection path includes a transition area between a first segment and a second segment of the at least one selection path, and wherein when the operator touch gesture moves the image into said transitional area, an operation mode of the transmission is selected corresponding to an interruption in transmission torque.

5. The operating device according to claim 1, wherein the haptic guide element includes more than one selection path, and wherein each selection path is geometrically unique from all other selection paths of the haptic guide element.

6. The operating device according to claim 1, wherein the predetermined area for selecting the operation mode of the transmission is displayed on the touch sensitive display.

7. The operating device according to claim 1, wherein a braking selection path is included to increase an engine braking and/or electric motor braking of the automobile, and wherein the engine braking and/or electric motor braking can be incrementally increased in accordance with the distance the image is moved by the touch gesture of the operator.

8. The operating device according to claim 1, wherein the haptic guide element is a molded plastic element, and wherein the selection path is formed by an elevated and/or depressed contour of the molded plastic element.

9. The operating device according to claim 1, wherein a surface of the haptic guide element includes at least two surface textures, the textures by including the surface of the touch sensitive display and/or a molded plastic attachment of the touch sensitive display.

10. The operating device according to claim 1, wherein the haptic guide element includes an electrostatic layer for inducing tactile response on the surface of the touch sensitive display.

11. A method, comprising:
forming an operating device for a shift by wire assembly in an automobile, the operating device including:
a touch sensitive display for selecting an operation mode of a transmission of the automobile; and
a haptic guide element configured to guide a touch gesture of an operator corresponding to the selection of the operation mode,
wherein the touch sensitive display is configured to display an image, the image being a graphical, interactive user-interface object that can be moved with the touch gesture of the operator into a predetermined area of the touch sensitive display for selecting the operation mode, and
wherein the haptic guide element includes at least one selection path along which the image can be moved.

12. The method of claim 11, wherein the at least one selection path includes a first segment and a second segment, wherein the first segment is oriented such that the image can be moved along a first direction and the second segment is oriented such that the image can be moved along a second direction, the second direction being different from the first direction and not the opposite of the first direction.

13. The method of claim 11, wherein the touch sensitive display is configured to display the image at a start position and/or move the image to the start position in a passive operating state, and wherein the touch sensitive display is configured to display the image based on the touch gesture of the operator in an active operating state, and wherein the touch sensitive display transitions to the passive operating state after the operation mode of the transmission has been selected.

14. The method of claim 11, wherein the selection path includes a transition area between a first segment and a second segment of the at least one selection path, and wherein when the operator touch gesture moves the image into said transitional area, an operation mode of the transmission is selected corresponding to an interruption in transmission torque.

15. The method of claim 11, wherein the haptic guide element includes more than one selection path, and wherein each selection path is geometrically unique from all other selection paths of the haptic guide element.

16. The method of claim 11, wherein the predetermined area for selecting the operation mode of the transmission is displayed on the touch sensitive display.

17. The method of claim 11, wherein a braking selection path is included to increase an engine braking and/or electric motor braking of the automobile, and wherein the engine braking and/or electric motor braking can be incrementally increased in accordance with the distance the image is moved by the touch gesture of the operator.

18. The method of claim 11, wherein the haptic guide element is a molded plastic element, and wherein the selection path is formed by an elevated and/or depressed contour of the molded plastic element.

19. The method of claim 11, wherein a surface of the haptic guide element includes at least two surface textures, the textures including the surface of the touch sensitive display and/or a molded plastic attachment of the touch sensitive display.

20. The method of claim 11, wherein the haptic guide element includes an electrostatic layer for inducing tactile response on the surface of the touch sensitive display.
